(19) United States
(12) Patent Application Publication
(10) Pub. No.: US 2008/0178198 A1
(43) Pub. Date: Jul. 24, 2008

(54) Distributed digital media management

(75) Inventor: Ravi Gauba, Fremont, CA (US)

Correspondence Address: Ashok Tankha, Lipton Weinberger & Husick, 36 Greenleigh Drive, Sewell, NJ, 08080, US

(73) Assignee: Media Ripple, LLC, Fremont, CA (US)

(21) Appl. No.: 11/656,191

(22) Filed: Jan. 22, 2007

(51) Int. Cl. G06F 9/44

(52) U.S. Cl. 719/320

(57) ABSTRACT

Disclosed herein is a method and system of discovery, management, access and control of digital contents distributed over a plurality of heterogeneous digital devices. A distributed digital media management middleware is provided on each of the devices that discovers, streams, moves, and synchronizes content among the devices. The distributed digital media management middlewares are interconnected to provide a unified directory of digital content present over the digital devices. Metadata objects are created for each of the devices and content. These metadata objects are used for control and management of digital content available on any of the plurality of devices.

### BACKGROUND OF THE INVENTION

This invention relates to a system and method of digital content management and in particular relates to a method and system of discovery, management, access and control of digital content distributed over a plurality of heterogeneous digital devices.

Within a home, there are often multiple digital devices containing a large amount of digital data like photos, video, music, etc. A consumer today also has a vast amount of digital content available from the Internet and other service providers such as cable television (TV) and self generated content through camcorders, digital cameras, etc. The amount of digital content is distributed among a multiplicity of devices such as personal computer (PC), compact disk (CD) players, cell phones, etc. The distributed nature of the digital content makes it difficult for the user to remember where his digital content resides.

The home environment is evolving with the advent of digital technologies. Connected digital devices are enabling a new generation of services and applications in the home. Recent adoption of digital technology at home has demonstrated the eagerness of the consumer to use digital technology even though this has been a cause of frustration for many consumers. Though the computing world has been developing applications and using these applications in a complex enterprise environment for many decades, use of these applications in the home environment requires the end user to have technical and management expertise and administration that the end user in a home often lacks. In order to facilitate adoption and use of technology and smart applications within the home, the application platform has to be architected to meet the demands and requirements for the home. The heterogeneous devices within the home vary in resources and capability. Additionally, the home environment includes multi-user relationships within a family. Current systems generally do not support the multi-user requirements of the home user.

Typically complex enterprise environments have deployed content management systems (CMS) to manage different digital content in the enterprise and the web. These CMS have been designed and used to manage digital content, production of digital content, and cataloging of digital content. The heterogeneous device environment consisting of mobile devices such as MP3 players, mobile phones, digital cameras, etc. have unique characteristics and CMSs that are currently available are not ideally designed for the these devices. For example, the current systems are designed to reside on computers and tend to be resource intensive. There is an unmet market need for a unified mechanism for content management and discovery for all user devices irrespective of device resources. Additionally, for mobile digital devices there is a market need to encompass user devices irrespective of the device location i.e. home, work, etc.

In current systems, the user is responsible for keeping track of all the digital content located over a multiplicity of devices. With an increase in the amount of digital content, there is a growing need for an automated system for facilitating a user to manage this content. There exists a market need for a “non device centric” model of discovery, management, access and control of digital contents distributed over a plurality of heterogeneous digital devices, and a market need for providing a mechanism to track content available over the internet. The solution needs to provide a unified mechanism for content management and discovery of content that is present locally or on remote devices.

Current device control technologies and home networking technologies such as Universal Plug and Play (UPnP) are device centric in that they do not provide an easy mechanism to track content on the devices. They provide the ability to discover devices and then the user can browse for content on each of the devices. To manage content, there needs to be a mechanism to discover, track and control content on the users devices. The current device centric technologies used to communicate with devices require the application programmer to be aware of the devices and be able to access the devices to access the content. These existing middleware platforms do not provide the support needed by the application programmer to discover content directly in a heterogeneous device environment. Additionally the application programmer needs to mange and control devices on the network, hence the applications built using the current technologies loose the content focus that is required by the user. The application should have the constructs to be able to use the middleware to perform actions such as “Play movie on Living Room TV” where the user is able to specify or name his devices (‘Living Room TV’).

Also the drawbacks of a device centric model is that similar devices with the same basic functionality may have varying parameters and formats based on device manufacturer or the different underlying home networking technologies. As new devices are frequently provided with new functionalities, application programmers should be able to write an application that would automatically work with these new devices, but this is not the case as the applications have to be updated for the new device functionality.

Another drawback of the current home networking technologies is that they lack user awareness and the user preferences have to be maintained by the applications. While the content being accessed requires user awareness, for example, what a child may like to listen to, or the content of his library may be very different from his parents content library.

### SUMMARY OF THE INVENTION

The method and system disclosed herein enables content discovery, control and management within a device, a group of devices, or the internet. The content may be managed on a heterogeneous set of devices. The method and system disclosed herein allows a user to search and interact directly with the content by using metadata objects. These metadata objects point to the actual content or to a device. The metadata objects contain not only descriptive information but also contain control information on the content along with the current status of the content. Hence, the application programmer can issue commands directly on the content without requiring an understanding of the underlying device details, thereby enabling an approach to discovering, tracking, managing and controlling content within the home along with being user aware. The user information and user preferences are maintained along with the content information.

The method and system of this invention overcomes the drawbacks of a device centric model. The method and system of present invention associates commands and controls to the contents, thereby providing the user a means of controlling digital content. The method and system provides an abstraction over the device-centric layer of control, which facilitates control over digital content irrespective of the devices. The method and system abstraction by the system of the present invention hides low level device interfaces and differences in device control technologies.

The approach of the method and system disclosed herein enables the application programmer to interact directly with the content items in the system, and the application programmers are not required to interact directly with the devices. The approach of the method and system enables application programming interface (APIs) that are not dependent on device functionality, rather, they are based on the actions that can be performed on the content item. The approach of the method and system provides uniform APIs that can facilitate automation of task and minimize user interactions. The approach of the method and system disclosed herein reduces operational complexity by hiding the low level device and home networking technology details from the application programmer. The approach of the method and system disclosed herein allows the application programmer to write applications with little or no knowledge of the underlying home networking technologies, device models, etc. The application programmer can rely on having access to the required functionality through the metadata objects.

Disclosed herein is a method and system of content discovery, control and management of digital media in a plurality of devices. An instance of middleware called distributed digital media management (DDMM) middleware is provided as an implementation of the method and system. This middleware resides on each of the devices. This middleware provides support to discover, stream, move, and synchronize content amongst the devices. The distributed digital media management middleware are interconnected to provide a unified directory of digital content present over the digital devices. Metadata objects are created for each of the content items on the device(s). A metadata object is a digital data or digital content that hold content and information associated with the content. Identifiers are provided for the metadata objects. A metadata object manager (MOM) performs metadata object discovery, control and management of digital media from any of the plurality of devices.

The method and system disclosed herein enables one or more digital devices among a multiplicity of digital devices to access, process and act upon the digital content existing on a multiplicity of digital devices. DDMM middleware creates and manages metadata objects that contain a pointer to the content and other information that describes the content. Any middleware can query a group of middleware on devices for a specific content or specific type of content. The method enables search for the content on a set of devices to enable content browser functionality, for both local and remote content. For devices that may not currently be active or connected to the network, the metadata objects are cached to enable access to the offline content information.

The distributed digital media management (DDMM) middleware provides a unified directory of digital content present over the digital devices. The distributed digital media management middleware contains metadata objects. These metadata objects are created by an adaptor of the DDMM middleware. The adaptor is a software component that can communicate with the device locally or over a network to discover content.

The middleware provides an abstraction over the devices and device control. This abstraction allows the application developer to build DDMM applications with no prior knowledge of the underlying devices.

The method and system disclosed herein facilitates the tracking of digital data distributed over local or remote devices. The method and system disclosed herein provides a central grouping and tagging of digital content distributed over a plurality of heterogeneous digital devices to facilitate retrieval of the content of interest. The grouping of digital content is defined in the metadata objects and is independent of applications and devices.

The method and system disclosed herein facilitates caching of contents of devices that are offline and not available to the distributed digital media management middleware at the time of the query by the DDMM application.

The method and system disclosed herein allows the application programmer to write DDMM applications with little or no knowledge of the underlying home networking technologies, device models, etc. The application programmer can rely on having access to the required functionality through metadata objects.

The method and system disclosed herein allows a user to discover, stream, move, and synchronize content amongst a group of digital devices present in a home environment network.

The method and system disclosed herein allows the application programmer to interact directly with the content items in the system where the application programmer is not required to interact with the devices.

The method and system disclosed herein enables application programmer interface (APIs) that are based on the actions that can be performed on the content item rather than being dependent on device functionality.

The method and system disclosed herein provides user awareness to access and group content along with a mechanism for a user to associate preferences with the content and content use. Hence, any DDMM application can take advantage of the user preferences once provided by the user for a specific content.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary constructions of the invention; however, the invention is not limited to the specific methods and instrumentalities disclosed herein.

FIG. 1 illustrates a method to discover, track, control and manage content and information associated with the content in a plurality of devices.

FIG. 2A exemplarily illustrates a metadata object.

FIG. 2B exemplarily illustrates the process of tracking different instances of the same content and edited copies of the same content.

FIG. 2C illustrates the exemplary constituents of a metadata object.

FIG. 2D illustrates the exemplary constituents of a metadata object.

FIG. 3 exemplarily illustrates the functional flow and the process of management of metadata objects.

FIG. 4 exemplarily illustrates the architecture of the distributed digital media management middleware (DDMM).

FIG. 5 exemplarily illustrates a method of updating an application program interface in the distributed digital media management asset manager.

FIG. 6 exemplarily illustrates a prototype of the (DDMM) middleware.

FIG. 7A exemplarily illustrates the metadata object manager interface class.

FIG. 7B illustrates an exemplary API to verify if a metadata object already exists in metadata object manager.

FIG. 7C exemplarily illustrates the ‘GetAssets’ API to perform a search on the DDMM asset base class.

FIG. 8 exemplarily illustrates the DDMM middleware interface.

FIG. 9 exemplarily illustrates the class diagram for DDMM middleware media interface.

FIG. 10 exemplarily illustrates the play command provided to a media player with the appropriate reference to the stream.

### DETAILED DESCRIPTION OF THE INVENTION

### DEFINITIONS

Content: Content refers to multimedia data, a software component, physical device, media such as DVD, flash memory, etc. It can also be an abstract entity such as ambiance defined to control the user environment. Content is used to define any real world item that can be mapped into the middleware and described by a metadata object and used by the DDMM application and in turn by the user.

A content is accessible through a device which is an entity with a central processing unit (CPU) and memory/storage. This storage may be removable storage such as DVD, USB drive, etc. The device itself is mapped as a piece of content item into the DDMM middleware.

Metadata object: A metadata object is created for each content that is expressed in the DDMM middleware and is used to track the content. The metadata object includes content items and devices. Each metadata object contains a pointer to the actual content and information associated with that content. This pointer is a mechanism to uniquely access the piece of content that is referenced by the metadata object. This mechanism is a universal resource locator (URL) or a piece of software code that when executed provides capability to access the content.

The metadata object is exposed to the DDMM application, enabling the DDMM applications to search, control and manage content items. Each metadata object has a type associated with it that is used by the DDMM application to distinguish between the different types of content referenced by the metadata object.

Device: A device is a digital hardware that can run the DDMM middleware, or is a digital hardware that the DDMM adaptor can communicate with to access the content and functionality exposed by the device.

DDMM Application: DDMM Application is a piece of software that uses the DDMM middleware to search or control content, for example a new application can use DDMM middleware to render content i.e. a video player application. Other example of DDMM application can be a content browser that the end user can use to mange his content. The DDMM application can also be used to locate user content on different devices and media. The application is any piece of software developed using DDMM middleware for controlling, discovering, browsing and for managing the content.

User: The user is the end user of the DDMM application built using DDMM middleware.

Application Programmer: The application programmer is the programmer who writes the application that interface with the user and may use the DDMM middleware.

Device Centric: In a device centric solution, devices are central to the programming model and it provides a mechanism to discover devices that can be controlled by the applications.

User Awareness: User awareness is the ability of DDMM middleware to recognize different users and produce discovery results based on user access rights. Additionally the DDMM middleware provides the ability for each user to organize content and use content based on these preferences.

Adaptor: The adaptor is a DDMM middleware component. Adaptors enable a range of technologies to plug into the middleware. This plug-in architecture provides a solution to build a modular middleware that is extensible. The adaptor enables support for home networking platforms, context aware platforms and peer to peer technologies, to interface with the middleware. An adaptor additionally provides an interface to devices and different content storage mediums such as file system on a device.

The adaptors can be developed to discover content on websites. For example, the adaptors can be designed as a web-crawler or a website parser that connects over the internet to access the websites. A query is used to define the filter for the type of content that needs to be discovered or the adaptor can be configured to limit or filter the search for specific content, i.e., video files on a given website or linked to the website within ‘n’ levels. The adaptor creates a metadata object for each piece of content that it finds on the website. These metadata objects can then be used by the DDMM application to render the online content.

Track: “Tracking” is a process that allows the DDMM middieware to access the content as the content location changes, i.e., enabling the DDMM middleware to map the content to the new location when it changes locations on a device or storage associated with a device.

Discover: To “discover content” is the ability to introduce content into DDMM middleware and the ability of the DDMM application to find the content by querying for metadata objects that in turn provides access to the content.

Control: The ability of changing the state of the content where content can be rendered streamed, shared, moved, deleted by use of commands associated with that piece of content.

Management: “Management” is the ability of the middleware to catalog, track, synchronize and update a piece of content and associated information.

Middleware: “Middleware” is a software that connects two or more software components together so that they can exchange data.

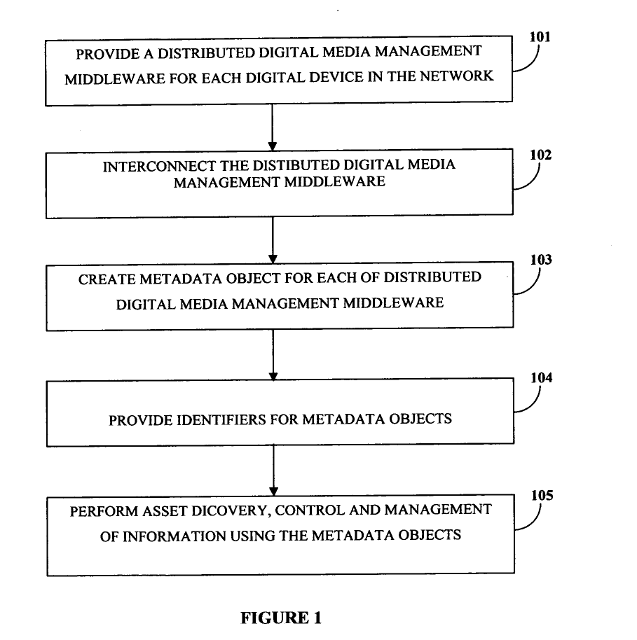

FIG. 1 illustrates a method to discover, track, control and manage content and information associated with the content in a plurality of devices. The distributed digital media management (DDMM) middleware 302 is provided on each of the digital device in the network 101. The DDMM middleware 302 are interconnected 102 to provide a unified directory of digital content present on the devices. DDMM middleware 302 comprises metadata objects 201. DDMM adaptors 304 are provided within the DDMM middleware 302 for the creation of metadata objects 201. When a new device or a new content is added to any device in the network, the DDMM adaptor 304 creates a new metadata object 103 and populates the required metadata fields associated with the new content or the new device. The DDMM adaptor 304 provides the ability to communicate with the devices. The DDMM adaptor 304 creates metadata objects representing the content on the devices accessed via the DDMM adaptor 304. Additionally, the DDMM adaptors 304 can be developed to discover content on websites also.

The metadata objects 201 are provided with identifiers 104. A new metadata object 201 is passed to a metadata object manager (MOM) 303 by the DDMM adaptor 304 for storage and use. MOM 303 performs metadata object discovery, tracking, control and management of content and information associated with the content 105 by discovery, tracking, control and management of the metadata objects 201. The metadata object manager 303 caches information associated with the content introduced into the DDMM middleware 302 to enable access to the information associated with the content even when the content is not accessible. MOM 303 sends notification of creation, update or removal of a given metadata object 201 to all devices in the network. The management of digital media by the DDMM middleware 302 comprises cataloging, tracking, synchronizing and updating a piece of content and associated information. The control of digital media by the DDMM middleware 302 implies the ability to change the state of the content. The content can be rendered, streamed, shared, moved and deleted by use of commands associated with that piece of content.

Content or digital content may be a multimedia data, a software component, physical device, media such as digitally versatile disk (DVD), flash memory, etc. The metadata object not only represents digital content but can also be used to represent physical items such as people and the device itself. Hence, an DDMM application 301 has a unified view of real world objects associated with the content and a unified mechanism to access them. When the content is a device, the device functionality is exposed by the metadata object. When the meta object represents a person, information such as user preferred contact (e-mail ID, or phone number) are included along with information such as the preferred mode communication.

The DDMM middleware 302 provides a central grouping and tagging of digital content distributed over a plurality of heterogeneous digital devices to facilitate retrieval of content of interest. The grouping of digital content is defined in the metadata objects and is independent of DDMM applications 301 and devices.

The discovery of metadata object 201 enables access to the content. If content is currently inaccessible, information to enable access to the content is provided to the user via the DDMM application 301.

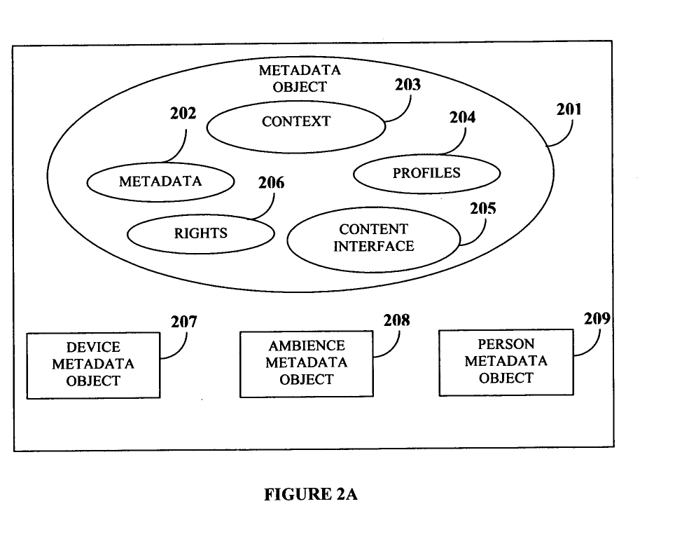

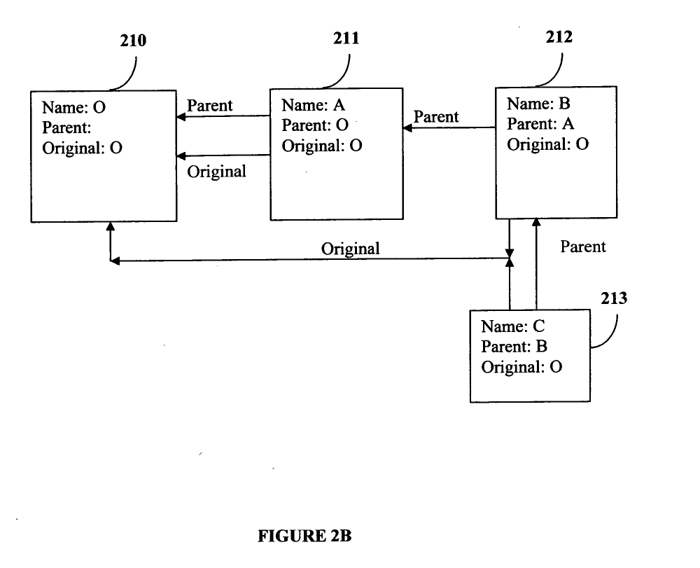

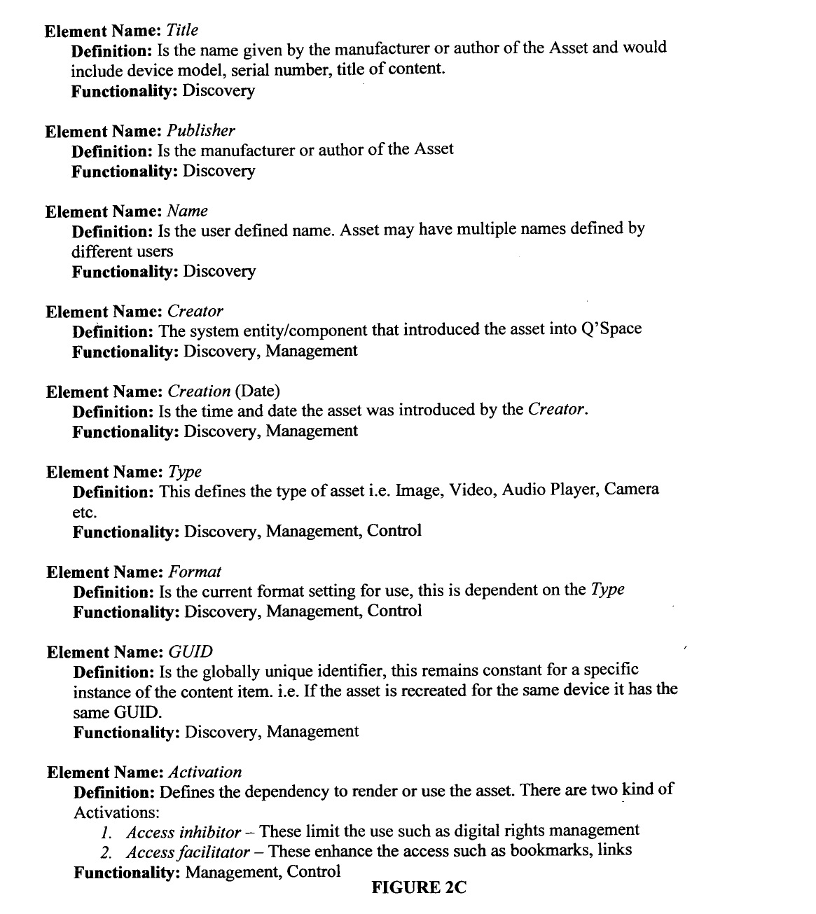

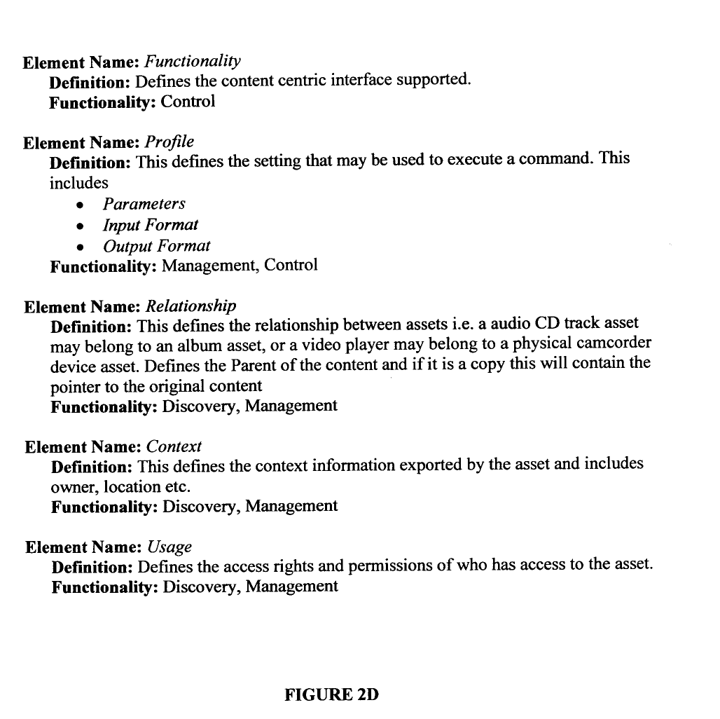

FIG. 2A exemplarily illustrates a metadata object 201. Metadata objects 201 are a representation of real world items that the user may perform actions on, or request information on. A metadata object 201 is a piece of digital data or digital content present on any digital device in the network. A metadata object 201 in the DDMM middleware 302 is an object that holds metadata 202 associated with the content. In another embodiment, the metadata object may also hold the actual content itself. The metadata objects 201 are populated with information from device configuration, adaptor configuration, user preferences and setup.

Metadata 202 is required for discovery, tracking, management and control of metadata objects 201. Metadata 202 includes information on the content within the metadata object 201 such as context 203, i.e., location or owner, content capability, content status, user defined attributes and system defined attributes. Profiles 204 are used to define the setting that may be used to execute a command. Parameters, input format, output format comprise a profile. Profiles are responsible for managing and controlling a metadata object 201. The term ‘content’ in the DDMM middleware 302 represents items that are considered as contents, such as multimedia content. The contents and its characteristics are defined in the metadata 202.

The content interface 205 is an API interface used to control content. An application programmer and a user may control the content by obtaining the content interface 205 associated with the metadata object. The content interface 205 facilitates the exchange of contents residing in each of the distributed digital media management middleware. The contents are managed by using a content pointer or reference. A pointer points to a specific content and the information associated with the content that describes the content located on the devices. To monitor content that is edited, a copy of that content is created along with an associated metadata object. The meta-data object keeps a pointer or reference to the original piece of content and a pointer to the content whose copy was made. The pointer to the content in the metadata object is a mechanism to uniquely access the piece of content that is referenced by the metadata object. This mechanism may be a URL or may be a piece of software code that when executed, provide access to the content. A pointer to the content enables access to the content such as image, video, audio player, camera, etc.

FIG. 2B exemplarily illustrates the process of assigning pointers to duplicated contents. For example, the original content 210 is named as O. The edited copy 211 is called A. In the copy A, the parent=O and original=O. Another edit is made to A. This copy 212 is called B. The original content points to O and the pointer content points to A. Similarly if another edit is made on B, the copy 213 is called C. Original content points to O and pointer content points to B. Whenever edits are made to the content, a new copy of the content is made along with a new metadata object. In this new metadata object, the original remains the same and the pointer points to the content whose copy was made. In the above example, if B was deleted, then C's pointer content is updated to point to A. Additionally, if the user ever wanted to either delete O with all its associated edits, or discover all edits associated with O, the original field in the metadata 202 can be searched to list all the edits.

Rights 206 are user specific media management rights that are assigned for the metadata objects 201. These rights grant the permission to access the metadata objects 201. The rights are user defined and programmable. Metadata objects 201 with restricted access are visible to only the users with granted permissions. The current security level must be equal to or greater than that of the metadata object 201 in order to access the metadata object 201. The metadata object 201 belongs to one or more of the active groups in the current context to be visible.

DDMM metadata object person 209 provides user awareness to the system, for example, defining relationships between the owner, friends and family in a home environment. User awareness is the ability of the system to maintain preferences based on the different users accessing the system, and the ability of the system to restrict access to the metadata objects based on rights given to different users of the system. DDMM ambience metadata object 208 provides environment awareness to control for example lighting, audio levels, temperature, etc. in a given environment. DDMM ambience metadata object 208 use sensors to get knowledge of the environment, or may query the relative devices. DDMM device metadata object 207 provides access to the underlying device control layer to access the devices directly. For example, a user may want to set-up some features in the device.

Each metadata object 201 associates one or more interfaces based on the capability of the content. For example an audio or video asset supports play, pause, skip, etc. These interfaces may be categorized into media, person, ambience, data and device interfaces. The media interface includes all multi media objects such as audio and video content items. The person interface holds the information about people in the system and their relationships. The ambience interface provides environment awareness in a given location or scope. The data interface provides awareness of data, digital streams, files, etc. The data interface provides a mechanism for synchronization and transfer of data items such as copying, or for moving a file. The device interface provides access to the underlying device access layer (such as UPnP) to directly access devices.

The approach of DDMM middleware 302 enables the application programmer to interact with the content items in the system without requiring the application programmers to interact directly with the devices. The approach taken by DDMM enables APIs that are not dependent on device functionality, rather the APIs are based on the actions that can be performed on the content item.

The approach of DDMM middleware provides uniform APIs that can facilitate automation of task and minimize user interactions. The DDMM middleware 302 hides the low level device and device control home networking technology details from the application programmer. The interfaces of the DDMM middleware 302 allows the application programmer to write DDMM applications with little or no knowledge of the underlying home networking technologies, device models, etc. The application programmer can rely on having access to the required functionality through the metadata object. An application programmer is a person who may write a DDMM application using the DDMM middleware that is then used by the end user to access content and devices.

The goal of the method and system disclosed herein is to abstract the device functionality away from the application programmer by enabling operations on the content item itself, instead of operating directly on the device. The DDMM middleware 302 associates commands and controls to the contents, thereby providing the user a means of controlling digital content. The DDMM middleware an abstraction over the device-centric layer of control, which facilitates control over digital content irrespective of the devices. Consider an example where a user wants to control the temperature in a room at a specific temperature. In the traditional home networking environment, the application programmer would have to directly interface with the thermostat device in the current location. In the method and system disclosed herein, the device interface is abstracted out and the application programmer can act directly on the ambience metadata object 208, i.e., the DDMM application and in turn the end user can request the system to maintain a certain temperature. The advantage of using the DDMM approach is that the application programmer has very similar generic interface when dealing with changing the temperature in the room, or setting the level of lighting in the room, or changing the volume of an audio device. Additionally the content based interfaces would not change based on underlying device control technology, or based on the manufacture or model of the thermostat.

The DDMM approach hides low level device interfaces and differences in device control technologies. For example, an audio object made about twenty years ago would have exposed commands such as play, stop, etc., similar to an audio object made today. Even though audio devices have improved in functionality and quality in their evolution from the analog to digital, the content items tend to remain almost the same in the functions they perform.

Each metadata object associates one or more content based interfaces on the capability of the content. For example an audio or video asset supports play, pause, skip, etc. Exemplary content based interface categories are defined below.

Media metadata objects comprise all multi media objects such as audio and video content items. It is primarily concerned with the presentation and rendering of the multimedia content. Examples of metadata objects are provided below.

Person metadata objects comprise information about people in the system, including defining relationships between the owner, friends and family.

Ambience metadata objects comprise information on environment awareness for controlling lighting, audio levels, temperature in a given location. Ambience may use sensors to get knowledge of the environment or may query the relative devices.

Data metadata objects provides awareness of data, digital streams, files, etc. It provides a mechanism for synchronization and transfer of data items such as copying or for moving a file.

Device metadata objects provide access to the underlying device access layer, such as UPnP to directly access devices. Though a content based interface environment has its advantages, there are many reasons for a user to access the device directly. For example, a user may want to set-up some features in the device. Each asset that represents a device exports this interface along with other content based interface that may apply for the functionality of the device.

Commands can be issued on the metadata object to change the state of the metadata object. The change in state of the metadata object represents an activity that occurs with the content. For example, being able to issue a play command on the Mpeg 2 type metadata object will cause its state to change to ‘playing’ and render the content associated with the metadata object.

FIG. 2C and FIG. 2D illustrates the exemplary constituents of a metadata object. For example, the constituent “title” is the name given by the manufacturer or author of the metadata object and would include device model, serial number and title of content. It is used for content discovery.

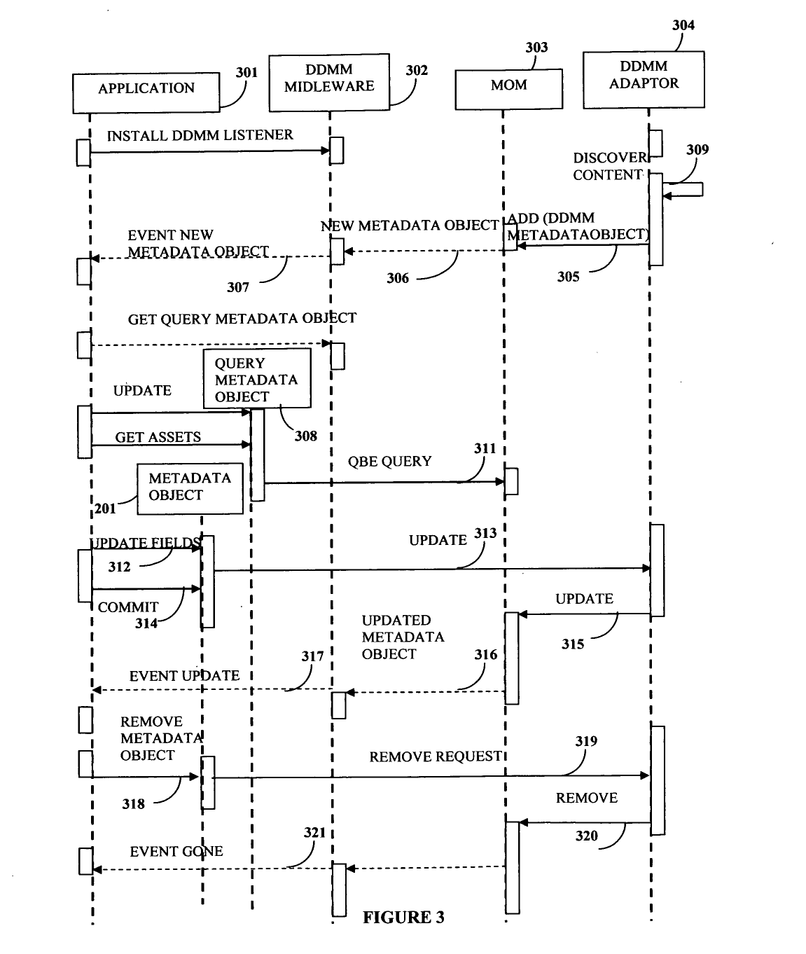

FIG. 3 exemplarily illustrates the functional flow and the process of management of metadata objects 201. Metadata objects 201 are central to the digital distributed digital media management middleware. Metadata objects 201 are created by DDMM adaptors 304 that interface with the underlying home networking stacks such as UPnP or device drivers such as camera and internet websites to discover digital content and map them into the DDMM middleware 302. On discovery of a new device or piece of content 322, the DDMM adaptor 304 creates a new metadata object and populates the required metadata fields. Each metadata object 201 is uniquely identifiable by an identifier (ID) that is used to track metadata objects 201 across multiple life cycles of a metadata object 201. The ID may be constructed by using the hardware ID of the device holding the content using the International Standard Recording Code (ISRC). This ID is created by the adaptor in a format defined by the DDMM. The ID provides the mechanism to uniquely identify and use a device or content item even if the metadata object 201 is deleted and recreated. The ID is used to create a Uniform Resource Locator (URL) for enabling access to the metadata object 201. After the metadata object 201 is created and ready for use, it is transmitted 305 to the MOM 303 for storage by the DDMM adaptor 304.

The new metadata object 201 is passed to MOM 303 by the DDMM adaptor 304 for storage and use. A DDMM application 301 built using DDMM middleware 302 may register to receive an event 307 to inform the DDMM application 301 of creation of a new metadata object 306. The DDMM application 301 defines a filter for events based on specific metadata 202 while registering to receive events from the MOM 303. The DDMM application 301 can be an array of DDMM applications 301 that are designed to use the distributed middleware. These DDMM applications 301 deal with digital content. For example, DDMM application 301 may be a photo management application, a media player application, etc. These DDMM applications 301 can reside on a number of devices such as a cell phone, personal digital assistant (PDA), a computer, etc. An DDMM application may be a piece of software that uses the DDMM middleware 302 to render content such as a music or video player. The DDMM application can be a content browser where the user can view his content on the distributed devices.

The MOM 303 sends a notification to all DDMM components interested in being notified of creation 307, update 317 or removal 321 of a given metadata object 201 from MOM 303.

Content is discovered and referenced with a metadata object 201 and indexed according to various criteria stored in the form of metadata 202. Metadata 202 does not merely describe by whom, when, and how a piece of content was created, but also contains dynamic context information and other information required to manage the content. The dynamic context information and information required to manage the content is used to maintain access to the content even when the content has moved location, or is accessible through a different device than from where it was previously accessed. The dynamic context information is information that helps locate the content at its current physical location, and includes state information such as online or offline status etc. To perform a search for a metadata object 201, a modified query-by-example (QBE) approach is used. The DDMM application 301 populates a query metadata object 308 with the parameters that the DDMM application 301 is interested in and performs a QBE query 311. The result of the query is the delivery of zero or more metadata objects 201 that meet the criteria. If the DDMM application 301 does not change any attribute values in the query metadata object template object, then all metadata objects 201 in the local instance of the DDMM middleware 302 are returned based on access rights of the current user. The query is transmitted through the DDMM adaptor 304. To query the remote DDMM middleware 302, the DDMM application 301 has to specifically request the remote instances that need to be included in the query.

An update 313 to the metadata object 201 may occur due to a change in state of the content pointed or referenced by the metadata object 201. The DDMM adaptor 304 updates 315 the metadata object state. Based on the configuration and resource availability, only the metadata objects 201 that are in use may get immediately updated 316 to reflect the current state of the actual content. The metadata object update event 317 is notified to the DDMM components. MOM 303 may run a background task to refresh the state of metadata objects 201 based on the metadata object configuration and refresh interval that may range from milliseconds to days. The refresh time can be changed to enable an appropriate update interval based on the type of metadata object 201 and its use. This is used to refresh the state and make sure that the metadata object references are consistent. The update to the asset state is configurable based on the system resources and DDMM application request for updating the state of an asset. For example the asset may be offline and the DDMM application may want to set the refresh rate of one second, hence, at one second intervals, the middleware will check to see the state of the content. This value is set by default by the middleware based on the resources and the CPU usage on the device running the middleware

MOM 303 provides the ability to remove 318 a metadata object 201 from the system. The DDMM adaptor 304 may remove the metadata object 201 once the pointed or referenced content is no longer available. Deletion of metadata objects 201 can also be forced 319 by MOM 303 where the content pointer or reference is no longer available for a preconfigured period of time and if computing resources for storage of metadata objects of the system falls below a configurable threshold. Only metadata objects 201 that contain pointers or references to content that are not reachable would be removed 320. Metadata objects 201 that may contain actual content are never removed automatically. A metadata object 201 that is updated by the DDMM application 301 is not deleted automatically as it may contain user updated preferences and metadata 202. The user preferences are contained in the metadata objects and these preferences are portable to any DDMM application, and are applied to the content irrespective of the DDMM applications.

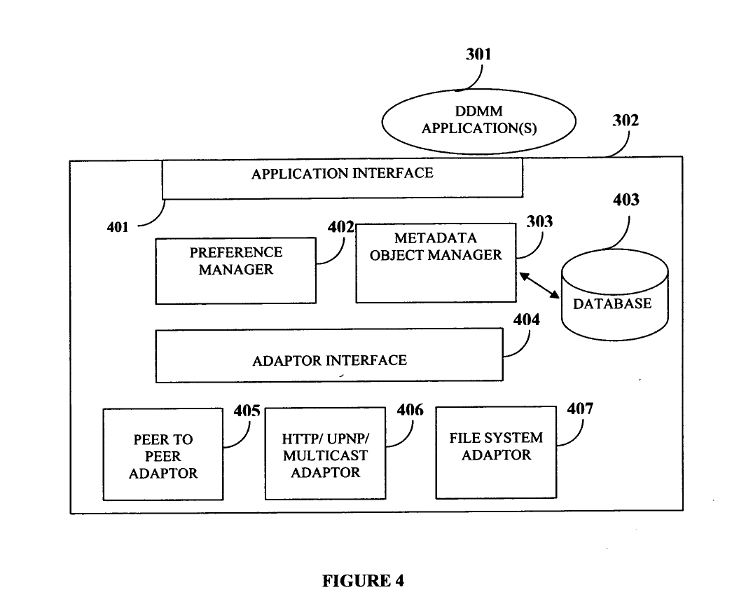

FIG. 4 exemplarily illustrates the architecture of the distributed digital media management (DDMM) middleware 302 to discover, track, control and manage content and information associated with the content in a plurality of devices. The distributed digital media management (DDMM) adaptor architecture provides a capability for middleware to interface with multiple underlying technologies. The DDMM adaptor interface 404 provides a plug-in architecture to access content on the network or on devices directly connected to the computer. These DDMM adaptors 304 create metadata objects 201 that are then managed by the middleware. Examples of home networking technologies and standards include Universal Plug and Play (UPnP), Home Audio/Video Interoperability (HAVi), etc. A DDMM adaptor 304 is developed for each of these home networking technologies that can introduce metadata objects 201 from the devices that exist on the home network. Storage means are provided on one or more of the devices for the storage of metadata objects.

DDMM adaptors 304 enable a range of technologies to plug into the middleware. This plug-in architecture provides a modular DDMM middleware 302 that is extensible. The adaptor 304 enables support for home networking platforms, context aware platforms and peer to peer technologies, to interface with the DDMM middleware 302. A DDMM adaptor 304 additionally provides an interface to devices and to different content storage mediums such as a file system on a device.

Hypertext Transfer Protocol (HTTP) and Multicast adaptor can also be employed in the plug-in architecture. The DDMM adaptor interface 404 enables support for connectivity topologies such as home networking platforms, peer to peer topology, etc. The DDMM adaptor interface 404 enables the systems to interface with middleware. The different DDMM adaptors 304 provide an abstraction over the underlying technologies there by making these different technologies to introduce their devices and content as metadata objects 201 into DDMM middleware 302.

The number of metadata objects 201 that DDMM middleware 302 can support depends on the underlying platform and resources. Creation and addition of metadata objects 201 that are transient involve performance and resource constraints. For example a mobile player such as an iPod™ of Apple Inc., USA may require the user to wait before all the content is mapped to metadata objects 201. To overcome performance and resource issues, DDMM middleware 302 provides the capability to configure a specific metadata object 201 or adaptor, to introduce child metadata objects only on request. This functionality is enabled by configuring the metadata object 201 or the adaptor to work in passive mode. A passively configured metadata object 201 will not introduce any of its child content into DDMM middleware 302. For example, a jukebox device metadata object or a mobile media player metadata object when set to passive mode will not introduce all the content it contains into DDMM middleware 302; rather it would receive a query and generate the appropriate list of metadata objects 201 based on the query. A DDMM adaptor 304 configured in passive mode would only add the root devices as metadata objects 201 into MOM 303. A query on these devices would be required to retrieve child metadata objects. This query may be performed as a background task to populate the metadata objects 201 from the passively configured DDMM adaptor 304, or require a direct request from the user, and is provided as a configuration option in DDMM middleware 302. The DDMM adaptor interface 404 enables the creation of metadata objects 201. The metadata objects 201 may be discovered or be created by providing a metadata object metafile. Metafile contains all the required attributes, profile and a link to the associated content.

To optimize the search for content, devices with resources such as set-top boxes and computers may be used to maintain a cached image of content that exists in the group of devices. The content itself is not cached, but the information about the content referred to as the metadata object 201 is cached. A metadata object 201 can be cached on any device with available resources. The choice to cache or not to cache is exposed to the end user by the application programmer through the application preferences of the preference manager 402. Maintaining a cached image of content facilitates the search for the content on a device that may not currently be active or connected to the network. For example, consider the case when a computer is connected to a camera. Each time the camera connects to the computer, the information cached on the computer about the content held in the camera would be updated with the current list of metadata objects 201 on that camera device. If the camera device is a legacy device, then the computer would create the metadata object 201 from the information on the device. A legacy device is one that does not contain the middleware, but the middleware on the computer still has access through adapters to access the content listing and/or content information on the legacy device.

The connectivity between associated remote DDMM middleware 302 is achieved through the communication module 408. The communication module 408 is used to discover remote metadata objects 201 and to export metadata objects 201 for remote discovery. A default web service adaptor is used to export content for remote discovery and used to discover remote content. The content exported is based on configuration, user preference and access rights.

MOM 303 integrates the overall architecture of DDMM middleware 302 to store, retrieve and manage metadata objects 201. The MOM design does not make an assumption regarding the database technology to be used, i.e., relational database or object database, rather the design focuses on the application interface 401 that is provided to the DDMM application 301. In another embodiment, the MOM 303 does not include a database 403 but stores metadata object in a transient memory. The design of MOM is based on an object oriented interface for the application programmer by using a query-by-example (QBE) oriented approach. The advantage of using QBE object-oriented API is that it provides a transparent mechanism for persistent store to the developer, and the developer does not need to learn different techniques to make use of different data stores. In order to define conditional queries, the query mechanism in object query language (OQL) is used to design the DDMM application program interface.

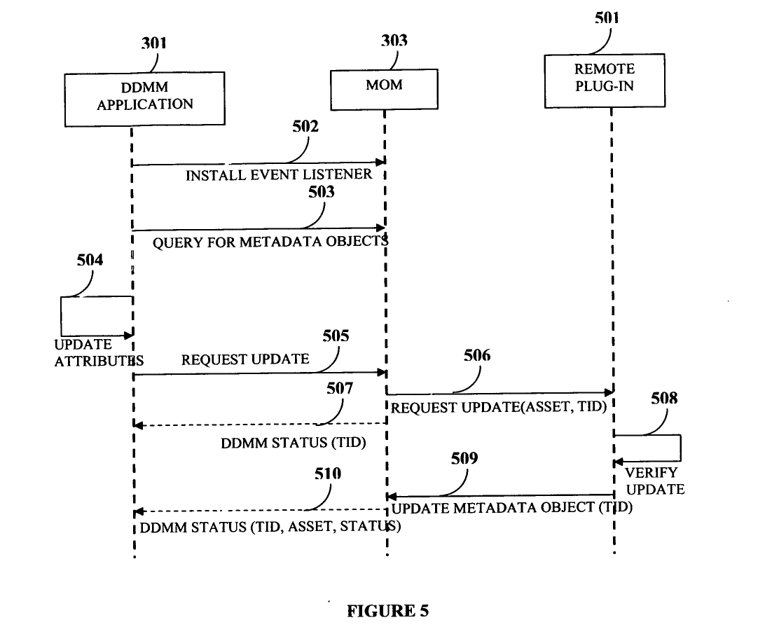

FIG. 5 exemplarily illustrates a method of updating an Application Program Interface (API) in the metadata object manager (MOM) 303. API is designed to support management and discovery of metadata objects 201 within the middleware. The MOM application programmer interface also has the capability to update the metadata fields within a metadata object 201. The following important functions are performed by the API: addition and deletion of metadata objects 201 is performed by DDMM adaptor 304. An event listener is installed 502 for tracking the events in the MOM 303. Following the query by example (QBE) approach, the programmer of the adaptor queries 503 and fetches a new instance of the metadata object 201 from the DDMM middleware 302. The middleware populates attributes associated with current context and adaptor information. The DDMM adaptor 304 populates the metadata 202 and adds the new instance of the metadata object 201 into MOM 303. The following API are provided as part of the metadata object instance QStatus AddAsset( ) and QStatus DeleteAsset( ). QStatus AddAsset( ) function is defined for the creation of an metadata object 201 into the MOM 303. QStatus DeleteAsset( ) function is defined for the deletion of an metadata object 201 from the MOM 303.

A model similar to QBE is used to update one or more attributes 504 in a metadata object 201. The application programmer retrieves the metadata object 201 and sets the value of the parameter within the metadata object to update and commit the change. Not all attributes of a metadata object 201 are configurable attributes. The ID and adaptor information can not be changed.

MOM 303 receives an update request 505 and generates a transaction ID (TID) that is returned 507 as part of the return value in the middleware. MOM 303 checks the values that are requested to be updated, and calls the appropriate DDMM adaptor 304 to validate the requested change in the value along with the transaction ID. The appropriate adapter is the one that created the metadata object 201 that is now being updated. Each metadata object 201 when created holds the URL to the adapter that created it. This acts as a unique ID and is used to discover the parent adapter. If the metadata object 201 is a cached metadata object 201 and an update request is issued, then the transaction is kept in the metadata object 201 to be applied. When the device holding the original metadata object 201 becomes available, then these requests are processed 510. Before making the requests, there are interfaces available to the application programmer to access the request and these requests may be cancelled or a user may be informed of the processing of the request.

Query on API is performed by MOM 303. The query API is based on the query-by-example (QBE) approach. When used in MOM 303, the QBE language of query creation enables the programmer to instantiate an instance of the metadata object 201 with the corresponding values that the programmer is interested to perform search on. All metadata objects 201 matching the search criteria are returned. If the programmer does not specify any values in the created instance of the metadata object 201, then all the metadata objects 201 that the current context has access to, are retrieved from the local MOM 303. The metadata object instance used to perform a query in the DDMM middleware 302 is an instance of the metadata object 201 called the ‘query metadata object’ 308 or ‘query asset’. A specific format of the call function in DDMM interface API may be exemplified as
QueryAsset DDMM.GetQueryAsset( )

API returns a metadata object 201 already populated with access constraints based on the currently active context. Additionally, the metadata object 201 contains metadata attributes required to perform a query on connected remote middleware instances 506. By default, the query encompasses only the metadata objects 201 in the local DDMM middleware 302. The application programmer can decide to include remote DDMM plug-in 501 by updating the attribute in the query metadata object 308. The remote plug in verifies the requested update 508 and returns a transaction ID (TID) 509 as part of the return value in middleware.

A specific format of the QBE based query object is QAssetList GetAssets( ). API returns zero or more metadata objects 201 that match the criteria set in the query metadata object 308. MOM 303 provides a helper function to get the default metadata object within the defined scope. The helper function may be exemplified as:
QAsset GetDefaultAsset( )
QueryAsset asset=DDMM.GetQueryAsset( );
asset.SetTitle(“Star Wars”);
QAssetList assetlist=asset.GetAssets( );

In another embodiment of the invention a mechanism to define conditional constraints for the query is provided. This may be exemplified as:
QAssetList GetAssets(ConstraintList c) function takes a list of constraints and returns zero or more metadata objects 201 that match the criteria set in the query metadata object 308. The results are filtered based on the provided constraint list. As used herein, the term ‘constraint list’ is a list of constraints defining the search criteria. The constraint list is defined similar to a Java data objects (JDO) interface and the queries are performed on the metadata objects 201 in the MOM 303. The constraint is constructed as follows:
Constraint(String attribute, Object value, Condition condition);
   As used herein, string attribute are the parameters that the constraint is subjected to. Object value is used as a condition for the search. Conditions are the specified criteria such as
“>,<,=,” etc.
   The following function exemplifies a simple query based on constraint.
QueryAsset asset=DDMM.GetQueryAsset( );
ConstrainList cl=new ConstrainList( );
cl.add(new Constrain(“QAsset.QStatus.value”, new Integer(10),
Condition.LESS_THAN));
QAssetList assetlist=asset.GetAssets(cl);

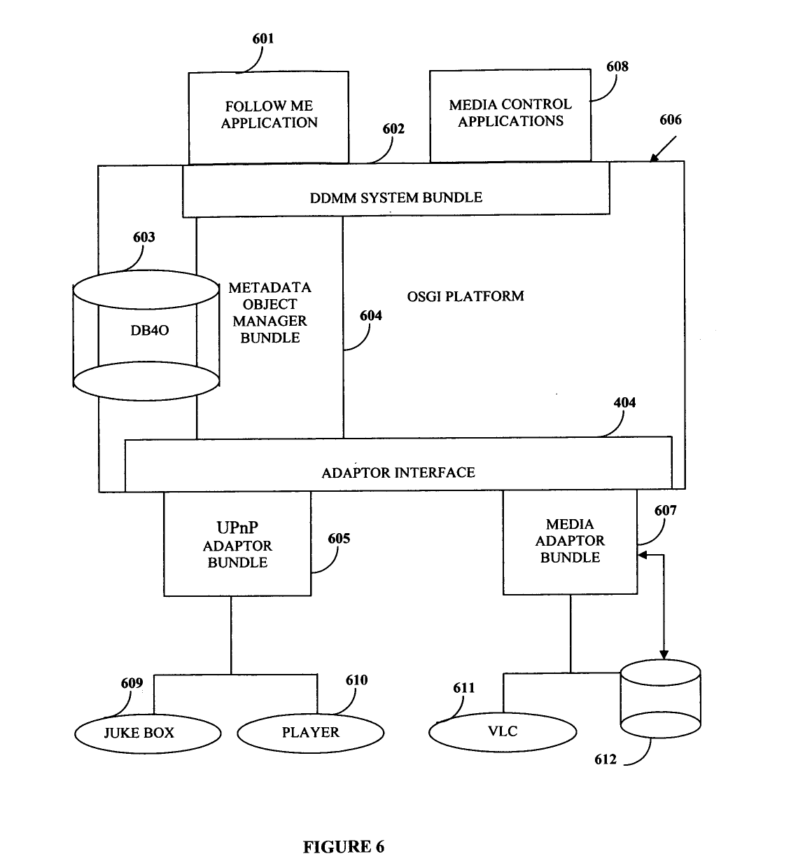

FIG. 6 exemplifies the DDMM middleware 302 along with the technologies used and the components developed to enable the application programmer to build DDMM applications 301 on the middleware. Each component of the middleware is built as a bundle on the open services gateway initiative (OSGi) framework or platform 606, such as metadata object manager bundle 604, UPnP adaptor bundle 605, media adaptor bundle 607. OSGi is a dynamic module system for Java™. The OSGI framework enables the DDMM middleware 302 to upgrade each component separately and enables a clear definition of interface for each component. To implement an exemplary DDMM middleware 302, the core technologies that are used are OSGI, DB4O 603, UPnP and the VLC Media Player Server.

The DDMM adaptor interface 404 is exposed to user applications such as follow-me applications 601 and media control applications 608 through a DDMM OSGI service. The DDMM OSGi service exports the DDMM adaptor interface 404 that enables the DDMM functionality. The DDMM adaptor interface 404 provides API for the applications 301 to communicate with the DDMM components such as jukebox 606, player 610, VLC 611 media player, and digital content storage 612. The DDMM OSGi service tracks the different DDMM components and provides access to the components, as needed by the DDMM application 301 or other DDMM components. Additionally, the DDMM service provides the functionality to install or uninstall the DDMM adaptor 304, and includes functionality such as providing the query metadata object 308 to discover metadata objects 201. The DDMM middleware 302 implementation is developed to run on Java 2 micro edition (J2ME). J2ME is a collection of Java API for the development of systems for resource-constrained devices.

The MOM 303 is implemented as a bundle with the MOM OSGi service. MOM service exports an interface to query, store, remove and update metadata objects 201 that are directly used by DDMM adaptors 304 to save and mange the metadata objects 201 and by query metadata object 308 to retrieve metadata objects 201 from MOM 303. The DDMM metadata object 201 is not a component in itself but a data object that is central to application interaction. The query metadata object 308 provides a set of attributes based on the metadata definition and is used by the DDMM application 301 to discover, control and manage devices and the associated content. The DDMM prototype implements all the DDMM components as bundles and exposes the DDMM functionality through DDMM OSGi services. The DDMM shared classes are packaged into a bundle installed on the OSGI platform 606. The bundle exports the common Java packages used by all the DDMM OSGI services that are installed and run in the OSGi framework.

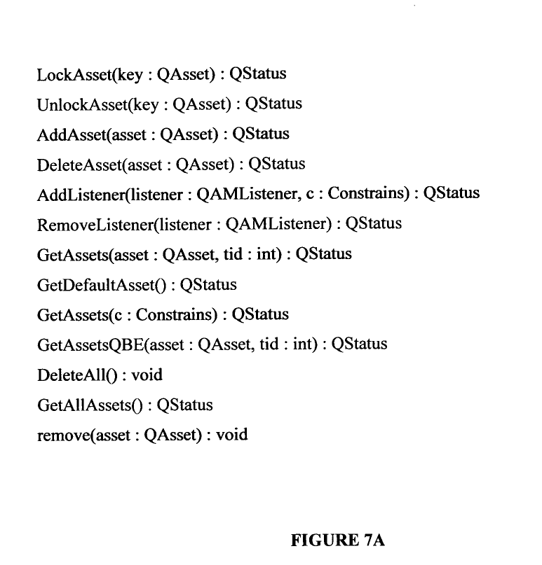

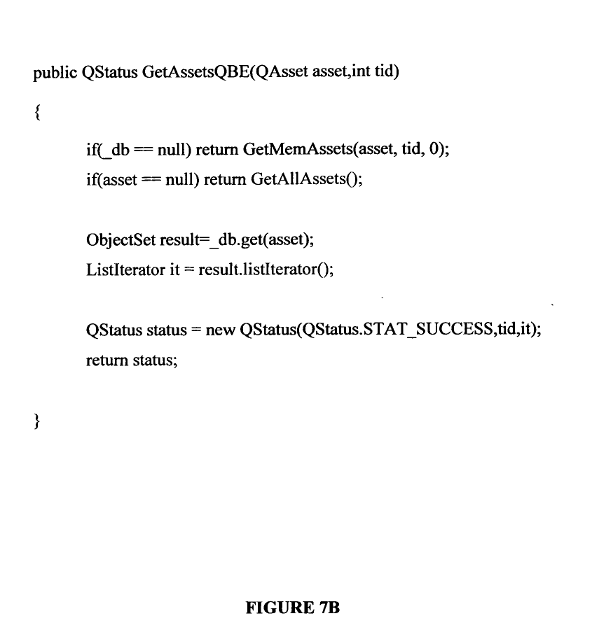

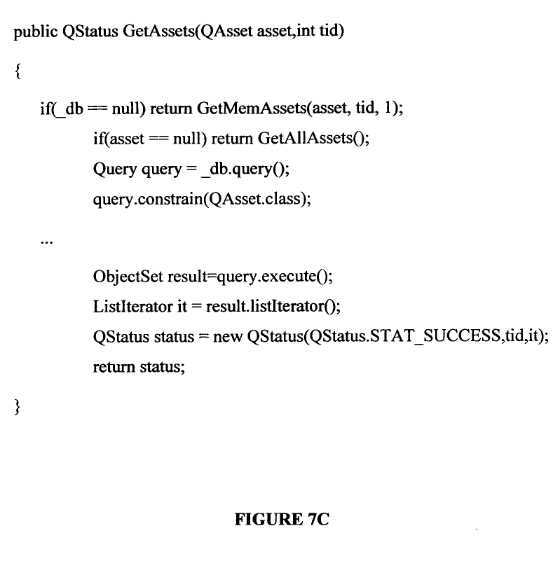

FIG. 7A exemplarily illustrates the metadata object manager interface class. In FIG. 7A, FIG. 7B and FIG. 7C, the term “asset” represents a metadata object. Three different operations are provided to query for metadata objects 201 in the DDMM middleware 302. The ‘GetAssetsQBE’ API is used by a DDMM adaptor 304 to perform a QBE search that verifies all the Java class interfaces implemented by the subclass of DDMM metadata object are the same. In db4o 603 the command is ‘ObjectSet result=_db.get(asset) and is used by the adaptor programmers.

FIG. 7B illustrates an exemplary API to verify if a metadata object already exists in metadata object manager.

The ‘GetAssets’ API does not check for all the implemented Java interfaces on the subclass of the DDMM metadata object abstract class.

FIG. 7C exemplarily illustrates the ‘GetAssets’ API to perform a search on the DDMM metadata object base class. For example ‘query.constrain(QAsset.class);’.

The ‘GetAllAssets’ API returns all metadata objects 201 without performing a check to see if any attributes in the query metadata object 308 were updated. Metadata object 201 that subclass from the DDMM asset abstract class are stored in MOM 303 specifying a ‘null’ DDMM metadata object, as a parameter in the previous two query APIs gets back all metadata objects 201 in the system.

```
public QStatus GetAllAssets( )
{
    if(_db == null) return GetMemAssets(null, 0, 1);
    ObjectSet result=_db.get(QAsset.class);
    ListIterator it = result.listIterator( );
    QStatus status = new QStatus(QStatus.STAT_SUCCESS,0,it);
    return status;
}
```

The ‘GetMemAssets’ API is an internal API to MOM 303 enabling the QBE approach to retrieve metadata objects 201 stored in transient memory.

The UPnP adaptor is a UPnP control point that discovers content on the UPnP network and introduces them as metadata objects 201 into the DDMM middleware 302. UPnP stack is available as a OSGI bundle and is used to implement a UPnP control point adaptor that discovers UPnP content and introduces them as metadata objects 201 with the media interface. The media adaptor is built to enable discovery, control and playback of multimedia content. For example in a MP3 player the media adaptor is designed to take a local directory containing MP3 content and add the content as metadata objects 201. The DDMM application 301 can specify the parameter where the files are located as shown:
Parameter param=(Parameter)asset.GetParameters( ).get(“DIR”);
param.setValue(myMusicDir);
QStatus stat=adap.Configure(asset.GetParameters( ));

Along with introducing the MP3 files as metadata objects 201, the media adaptor has been designed to add the VLC media player as a media metadata object. In the current implementation it adds two media players and connects with them over the VLC remote console using a transmission control protocol/internet protocol (TCP/IP) connection. The IP address of the two media player is configurable in the configuration file with the parameter name as ‘org.qs.np.player.room1’ and ‘org.qs.np.player.room2’. The location of the two players is set to ‘room1’ and ‘room2’.

The architecture defines numerous interfaces and abstract classes for implementation to aid the adaptor programmer. The DDMM asset abstract class is used by the DDMM adaptors 304 to subclass and create an appropriate DDMM metadata object that extends the required interface based on the type of metadata object.

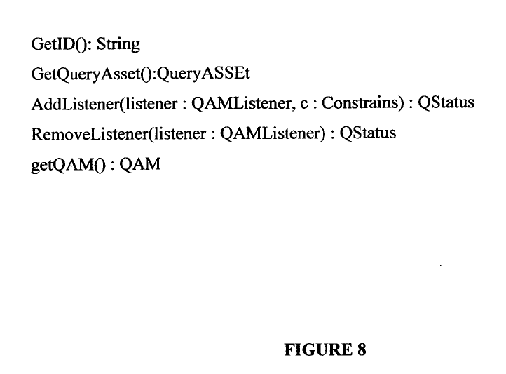

FIG. 8 exemplarily illustrates the DDMM middleware interface. The DDMM system bundle 602 exports a DDMM OSGi service based on the DDMM interface. The interface provides capabilities to get access to the query metadata object 308 and to the MOM 303 along with enabling access to the GUID that allows each DDMM middleware 302 to be identified uniquely. The interface is used both by the application programmer and the adaptor programmer to get access to the DDMM OSGi service. Once the programmers have access to DDMM middleware 302, additional DDMM components such as the MOM 303 and query metadata object 308 can be accessed. The query metadata object 308 is used to enable query-by-example approach in DDMM middleware 302. The query metadata object 308 is a subclass of the DDMM asset abstract class and provides function to set the attributes of DDMM metadata object 201, along with the API to perform synchronous query for metadata objects 201 managed by MOM 303.

The DDMM OSGi service API, public QueryMetadata object GetQueryAsset( ), returns the query metadata object 308 that can be used directly without setting any value to obtain all metadata objects 201 in MOM 303. The application programmer may set specific attributes to filter the results. For example to get all MP3 objects in DDMM middleware 302, the DDMM application 301 would perform the following steps.
QueryAsset queryAsset=GetDDMM( ).GetQueryAsset( );
queryAsset.setFormat(QFormat.MP3);
ListIterator li=qa.GetAssetsSync( );

The metadata object manager (MOM) 303 is used to store, update and retrieve DDMM metadata objects 201. MOM 303 can be configured to run using the database 403 or using transient memory to store the metadata objects 201. The QBE approach allows the same API to be used by application programmer to query for metadata objects 201 that are managed in memory or in a database 403. MOM 303 can be configured to use or not to use a database 403 based on a property in the configuration file. In database mode MOM 303 uses db4o 603 to enable persistent store of metadata objects. If the database 403 is to be used then the property, org.qs.qam.path, is set to specify the location of the database 403. MOM 303 can be configured to either use db4 objects (db4o) 603 as a persistent store or to store the objects in transient memory for devices that may not need a database 403. The db4o 603 is a high-performance, embeddable, open source object database for Java and provides support for QBE that is appropriate for the MOM requirements and runs on J2ME. The db4o 603 requires little or no database administration.

The application programmer does not directly interact with the MOM interface but rather uses query metadata object 308 to discover metadata objects 201 within DDMM middleware 302. The DDMM adaptor programmer uses the MOM interface for the storage, query and update of metadata objects 201.

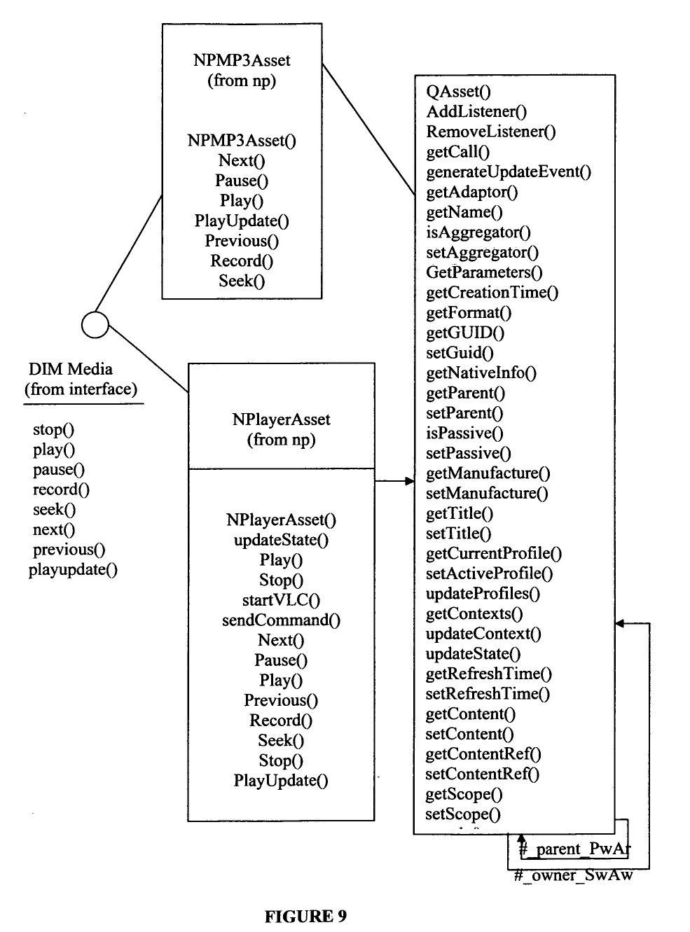

FIG. 9 exemplarily illustrates the class diagram for DDMM middleware media interface. To stream the MP3 content, the media adaptor connects to the VLC server using the telnet interface. The VLC telnet interface provides commands to enable multiple output streaming of content. When a request to play MP3 content is made by the user, the media metadata object uses the VLC server to initiate a multicast stream for the specified content. The media adaptor then searches for the appropriate media player to play the content based on scope. If the scope is not set it uses the first available player metadata object. Once the player is located, the play command with the appropriate reference to the stream is provided to the player.

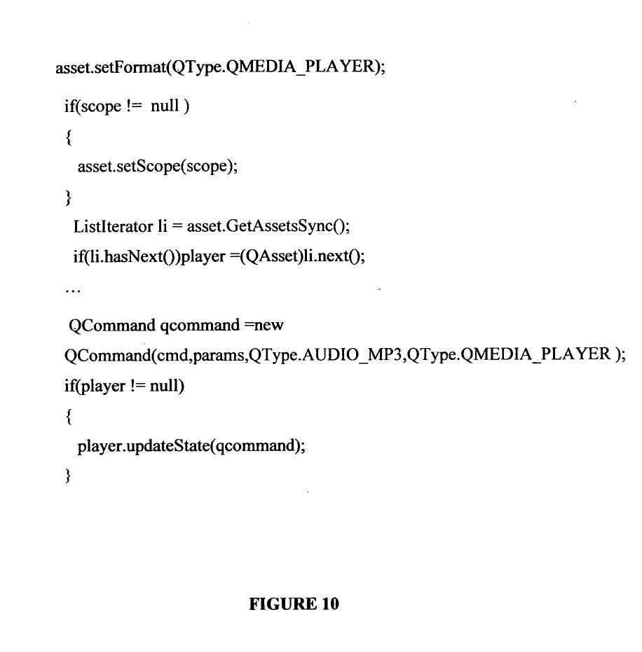

FIG. 10 exemplarily illustrates the play command provided to a media player with the appropriate reference to the stream.

The DDMM middleware 302 is specifically suited for an environment containing heterogenous devices operated by users who may not have a detailed knowledge of the connected devices. For example, the method and system of this invention is applicable to a user environment of connected devices, such as at home and at work. The home environment is evolving with the advent of digital technologies. Connected digital devices are enabling new generation of services and applications in the home. The user interaction with technology and the user expectation of reliability or usability are different then those expected in the workspace. In order to facilitate adoption and use of technology and smart applications within the home, the application platform is architected to meet the demands and requirements for the home. The DDMM middleware 302 deployed within the home have unique characteristics, since the heterogeneous devices within the home range in resources and capability. Additionally, the usage and family structure within the home provide a different multi-user environment than that experienced by applications in the workspace. The DDMM middleware 302 platform is a middleware platform designed specifically for the multi-user and heterogeneous device environment within the home. The DDMM middleware 302 performs control on the digital media. The DDMM middleware 302 provides an abstraction over the devices and device control. This abstraction allows the application developer to build applications with no prior knowledge of underlying devices.

The roles of an application programmer and a user may be performed by a single person. This can be achieved if the user has programming capabilities of the application programmer or if a simple scripting capability is provided to the user to enable the user to perform programming operations.

It will be readily apparent to a person with skill in the art that the various methods and algorithms described herein may be implemented as computer readable medium, e.g., appropriately programmed general purpose computers and computing devices. Typically a processor for example, one or more microprocessors will receive instructions from a memory or like device, and execute those instructions, thereby performing one or more processes defined by those instructions. Further, programs that implement such methods and algorithms may be stored and transmitted using a variety of media for e.g., computer readable media in a number of manners. In some embodiments, hard-wired circuitry or custom hardware may be used in place of, or in combination with, software instructions for implementation of the processes of various embodiments. Thus, some embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as object code.

Where databases are described, such as the object database, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspect.

I claim:

1. A method to discover, track, control and manage content and information associated with said content in a plurality of devices, comprising;
providing a distributed digital media management middleware in a plurality of said devices;
interconnecting said distributed digital media management middlewares;
creating metadata objects for said content on each of said devices, wherein metadata objects comprises of content or pointers to said contents;
providing identifiers for said metadata objects; and
performing said content discovery, tracking, control and management of the content and said information associated with said content by discovery, tracking, control and management of the metadata objects.

2. The method of claim 1, wherein each of said metadata objects contains a pointer to a specific content and information associated with said content that describes the content located on the devices.

3. The method of claim 1, wherein said metadata objects comprises of information on the location of the content, owner of the content, content capability, content status, user defined attributes and system defined attributes, wherein said attributes comprise information on how the content is grouped and named by the user.

4. The method of claim 1, wherein said metadata objects contain dynamic context information and information required to manage the content, wherein said dynamic context information and information required to manage the content is used to maintain access to the content even when the content has moved locations or is accessible through a different device than from where it was previously accessed.

5. The method of claim 1, wherein the metadata object is updated when there is a change in state of the content referenced by the metadata object.

6. The method of claim 1, wherein commands can be issued on the metadata object to change the state of the metadata object, wherein the change in state is an activity that occurs with the content.

7. The method of claim 1, wherein a search for a metadata object in the distributed digital media management middleware is performed in response to a query of a distributed digital media management application using the distributed middleware, and wherein the result of said query is the delivery of zero or more metadata objects that meet a search criteria of said query.

8. The method of claim 7, wherein the discovery of metadata object enables access to the content, and wherein if content is currently inaccessible, information to enable access to the content is provided to the user via the distributed digital media management application.

9. The method of claim 1, wherein user specific media management rights are assigned for the assets, wherein said rights grant permission to access the content, and wherein the rights are user defined and programmable.

10. The method of claim 2, wherein said pointer to the content enables access to the content such as image, video, audio player and camera.

11. The method of claim 1, wherein said identifier is a globally unique identifier that is used to discover and manage a metadata object, thereby identifying content even if the metadata object was previously deleted and then recreated.

12. The method of claim 11, wherein said identifier is constructed by using a hardware identifier of the device holding the content using an international standard recording code.

13. The method of claim 1, wherein said metadata objects are populated with information from device configuration, adaptor configuration, user preferences and setup.

14. The method of claim 1, wherein if the content associated with the metadata object is edited, a new metadata object is created that is associated with the edited piece of content, wherein said new metadata object contains a reference to both said content and said edited piece of content.

15. The method of claim 1, wherein child metadata objects are created on request when the metadata object or the adaptor is configured to work in passive mode.

16. The method of claim 1, further comprising the step of running a background task to refresh the state of metadata objects based on the metadata object's configuration.

17. A system to discover, track, control and manage content and information associated with said content in a plurality of devices, comprising;
a distributed digital media management middleware provided on each of said devices, wherein said middleware discovers, streams, moves, and synchronizes content amongst said devices;
said distributed digital media management middleware further comprising an adaptor component that provides the ability to communicate with said devices, and wherein said adaptors create metadata objects representing the content on the devices accessed via the adaptor;
storage means provided on one or more of said devices for the storage of metadata objects;
communication modules provided on the devices that establish connectivity between the devices;
an application interface for support management and discovery of said metadata objects; and
a distributed digital media management middleware metadata object manager that performs the update, removal and management of the metadata objects in the distributed digital media management middleware.

18. The system of claim 17, wherein the storage means is a database.

19. The system of claim 17, wherein the storage means is a transient memory.

20. The system of claim 17, wherein said distributed digital media management middleware adaptor interface supports home networking and peer to peer connectivity topologies.

21. The system of claim 17, wherein said application interface updates the metadata object by a query by example model.

22. The system of the claim 17, wherein said application interface retrieves the metadata object, and further sets the value of the parameter within the metadata object to update and commit the change.

23. The system of claim 17, wherein said distributed digital media management middleware metadata object manager sends notification to all the middleware components interested in being informed of creation or update of a given metadata object from the metadata object manager.

24. The system of the claim 17, wherein said distributed digital media management middleware metadata object manager cache information associated with the content once introduced into the middleware to enable access to said information associated with the content even when the content is not accessible.

25. The system of the claim 17, wherein said distributed digital media management middleware metadata object manager may delete a metadata object once the referenced content of the metadata object is no longer available for a preconfigured period of time and if computing resources for storage of metadata objects of said system falls below a configurable threshold.

26. The system of claim 17, wherein the distributed digital media management middleware further comprises a content interface that facilitates the exchange of contents residing in each of the distributed digital media management middleware.

27. The system of claim 17, wherein an application programmer and a user may control the content by obtaining the content interface associated with the metadata object.

28. The system of claim 17, wherein said metadata object further comprises a metadata object person that provides the user awareness to the system, including defining relationships between the owner, friends and family in a home environment, wherein the user awareness is the ability of said system to maintain preferences based on the different users accessing the system and the ability of the system to restrict access to the metadata objects based on rights given to different users of the system.

29. The system of claim 17, wherein said metadata object further comprises a metadata object ambience that provides an environment awareness to control lighting, audio levels and temperature in a home environment.

30. The system of claim 17, wherein said adaptor is a web crawler that discovers content on websites.

31. The system of claim 17, wherein the distributed digital media management middlewares are interconnected to provide a unified directory of digital content present over the plurality of devices.

32. A computer program product comprising computer executable instructions embodied in a computer-readable medium, said computer program product including:
a first computer parsable program code for providing a distributed digital media management middleware for each of said devices;
a second computer parsable program code for interconnecting said distributed digital media management middlewares;
a third computer parsable program code for creating metadata objects for said content on each of said devices, wherein metadata objects comprises of content or pointers to said contents;
a fourth computer parsable program code for providing identifiers for said metadata objects; and
a fifth computer parsable program code for performing said content discovery, tracking, control and management of the content and said information associated with said content by discovery, tracking, control and management of the metadata objects.

33. The computer program product of claim 31, further comprising a sixth computer parsable program code for updating the metadata object when there is a change in state of the content referenced by the metadata object.

34. The computer program product of claim 31, further comprising a seventh computer parsable program code for issuing commands on the metadata object to change the state of the metadata object, wherein the change in state is an activity that occurs with the content.

35. The computer program product of claim 31, further comprising an eighth computer parsable program code for running a background task to refresh the state of metadata objects based on the metadata object's configuration.
